(19) United States
(12) Patent Application Publication
(10) Pub. No.: US 2021/0263628 A1
(43) Pub. Date: Aug. 26, 2021

(54) MULTI-OPTION SWIPE GESTURE SELECTION

(71) Applicant: QUALCOMM Incorporated, San Diego, CA (US)

(72) Inventor: Rommel BHARGAVA, San Diego, CA (US)

(21) Appl. No.: 16/799,633

(22) Filed: Feb. 24, 2020

(51) Int. Cl. G06F 3/0487; G06F 3/0484; G06F 3/01

(52) U.S. Cl. CPC G06F 3/0487; G06F 3/017; G06F 3/04842

(57) ABSTRACT

Methods, systems, and devices for multi-option swipe gesture selection are described. The method includes displaying a user interface element on a screen of a device, sensing a swipe gesture on the screen that is associated with the user interface element, displaying a first option when a distance of the swipe gesture is determined to be within a first span, displaying a second option when the distance of the swipe gesture is beyond the first span and within a second span that is greater than the first span, sensing a selection gesture while displaying the first option or the second option, and executing either a first process based on sensing the selection gesture while displaying the first option or a second process based on sensing the selection gesture while displaying the second option.

### BACKGROUND

The following relates generally to user interfaces, and more specifically to multi-option swipe gesture selection.

The use of computer systems and computer-related technologies continues to increase at a rapid pace. This increased use of computer systems has influenced the advances made to computer-related technologies. Indeed, computer systems have increasingly become an integral part of the business world and the activities of individual consumers. Computer systems may be used to carry out several business, industry, and academic endeavors. The wide-spread use of computers has been accelerated by the increased use of computer networks, including the Internet.

Many businesses use one or more computer networks to communicate and share data between the various computers connected to the networks. The productivity and efficiency of employees often includes human and computer interaction. Users of computer technologies continue to demand an increase in the efficiency of these technologies. Improving the efficiency of computer technologies is desirable to anyone who uses and relies on computers.

The wide-spread use of computers and mobile devices has caused an increased presence of notifications from applications such as email, text messaging, social media, etc. Some systems allow a user to interact with a notification to perform an action. Some of these systems provide a user with one or two options (e.g., close notification, open application, etc.). Some of these systems request a user to perform multiple actions in addition to selecting an option to perform a user selected action. For example, some systems request a user to perform a first action, perform a second action, and then perform a third action based on the first or second action. Thus, some systems present a user with limited options in dealing with notifications, and require the user to perform multiple actions to execute a user selected action.

### SUMMARY

The described techniques relate to improved methods, systems, devices, and apparatuses that support multi-option swipe gesture selection. Generally, the described techniques provide for a swipe gesture selection mechanism that enables a user to select from multiple options of actions to perform relative to a notification. In some examples, a user may select an action to perform by swiping a notification (e.g., dragging a finger or screen interface pen across a screen of a device, clicking and dragging a mouse cursor, etc.) and releasing the swipe. Thus, the described techniques remove the constraints of other systems that constrain a user to perform two or more actions (e.g., swipe, then release, then tap screen, etc.) to perform an action associated with a notification.

A method of interacting with a user interface element at a device is described. The method may include displaying the user interface element on a screen of the device, sensing a swipe gesture on the screen that is associated with the user interface element, displaying a first option when a distance of the swipe gesture is determined to be within a first span, displaying a second option when the distance of the swipe gesture is beyond the first span and within a second span that is greater than the first span, sensing a selection gesture while displaying the first option or the second option, and executing either a first process based on sensing the selection gesture while displaying the first option or a second process based on sensing the selection gesture while displaying the second option.

An apparatus for interacting with a user interface element at a device is described. The apparatus may include a processor, memory coupled with the processor, and instructions stored in the memory. The instructions may be executable by the processor to cause the apparatus to display the user interface element on a screen of the device, sense a swipe gesture on the screen that is associated with the user interface element, display a first option when a distance of the swipe gesture is determined to be within a first span, display a second option when the distance of the swipe gesture is beyond the first span and within a second span that is greater than the first span, sense a selection gesture while displaying the first option or the second option, and execute either a first process based on sensing the selection gesture while displaying the first option or a second process based on sensing the selection gesture while displaying the second option.

Another apparatus for interacting with a user interface element at a device is described. The apparatus may include means for displaying the user interface element on a screen of the device, sensing a swipe gesture on the screen that is associated with the user interface element, displaying a first option when a distance of the swipe gesture is determined to be within a first span, displaying a second option when the distance of the swipe gesture is beyond the first span and within a second span that is greater than the first span, sensing a selection gesture while displaying the first option or the second option, and executing either a first process based on sensing the selection gesture while displaying the first option or a second process based on sensing the selection gesture while displaying the second option.

A non-transitory computer-readable medium storing code for interacting with a user interface element at a device is described. The code may include instructions executable by a processor to display the user interface element on a screen of the device, sense a swipe gesture on the screen that is associated with the user interface element, display a first option when a distance of the swipe gesture is determined to be within a first span, display a second option when the distance of the swipe gesture is beyond the first span and within a second span that is greater than the first span, sense a selection gesture while displaying the first option or the second option, and execute either a first process based on sensing the selection gesture while displaying the first option or a second process based on sensing the selection gesture while displaying the second option.

Some examples of the method, apparatuses, and non-transitory computer-readable medium described herein may further include operations, features, means, or instructions for providing a first feedback in conjunction with displaying the first option, and providing a second feedback in conjunction with displaying the second option.

In some examples of the method, apparatuses, and non-transitory computer-readable medium described herein, the first feedback or the second feedback includes at least one of a haptic feedback, or a graphical feedback, or an audio feedback, or any combination thereof.

In some examples of the method, apparatuses, and non-transitory computer-readable medium described herein, the selection gesture includes at least one of a release of the swipe gesture, or a second swipe gesture in a direction different than a direction of the swipe gesture, or sensing an increase in pressure applied to the screen, or any combination thereof.

In some examples of the method, apparatuses, and non-transitory computer-readable medium described herein, the release of the swipe gesture includes a lifting of a finger from the screen, a releasing of a mouse button, or a second swipe gesture by a hand in the air in an augmented reality associated with the screen.

In some examples of the method, apparatuses, and non-transitory computer-readable medium described herein, the user interface element includes at least one of a calendar reminder notification, or a link to open a calendar reminder, or an email notification, or a link to open an email, or a message notification, or a link to open a message, or a travel notification, or a paging notification, or a location notification, or a mapping route notification, or a link to open a mobile application, or any combination thereof.

In some examples of the method, apparatuses, and non-transitory computer-readable medium described herein, the first span includes a distance from a first point on the screen to a second point on the screen, and where the second span includes a distance from the first point on the screen to a third point on the screen.

In some examples of the method, apparatuses, and non-transitory computer-readable medium described herein, the device includes a mobile computing device, a personal computing device, a wearable computing device, a screen projector, or a virtual reality headset.

### BRIEF DESCRIPTION OF THE DRAWINGS

FIG. 1 illustrates an example of a system for multi-option swipe gesture selection that supports multi-option swipe gesture selection in accordance with aspects of the present disclosure.

FIGS. 2A, 2B, and 2C illustrate examples of a system that supports multi-option swipe gesture selection in accordance with aspects of the present disclosure.

FIG. 3 illustrates an example of a flowchart that supports multi-option swipe gesture selection in accordance with aspects of the present disclosure.

FIGS. 4 and 5 show block diagrams of devices that support multi-option swipe gesture selection in accordance with aspects of the present disclosure.

FIG. 6 shows a block diagram of a UI manager that supports multi-option swipe gesture selection in accordance with aspects of the present disclosure.

FIG. 7 shows a diagram of a system including a device that supports multi-option swipe gesture selection in accordance with aspects of the present disclosure.

FIGS. 8 and 9 show flowcharts illustrating methods that support multi-option swipe gesture selection in accordance with aspects of the present disclosure.

### DETAILED DESCRIPTION

Some systems allow a user to swipe a notification to perform an action. Some of these systems provide a user with one or two options when the notification is swiped (e.g., dismiss notification, archive notification, etc.). Some of these systems request a user to perform multiple actions in addition to swiping the notification in order to perform the action associated with the swipe. For example, some systems request a user to swipe, release the swipe, and then tap an action button shown on the display. Thus, some systems present a user with limited options in dealing with notifications, and request the user to perform multiple actions to execute an action.

The techniques described herein enable a user to perform an action by swiping a notification (e.g., dragging a finger or screen interface pen across a screen of a device) and releasing the swipe. Thus, the described techniques remove the constraints of other systems that request a user to perform two or more actions (e.g., swipe, then release, then tap screen, etc.) to perform an action associated with a notification. In some examples, the described techniques include displaying different actions associated with the notification based on how far a user swipes the notification (e.g., a distance of a swipe relative to an edge of a screen, a distance of a swipe relative to where the swipe is initiated, etc.). In some examples, the described techniques include showing a first option (e.g., a first optional action to take associated with the notification) for a swipe up to a first distance, showing a second option for a swipe up to a second distance beyond the first distance, showing a third option for a swipe of a third distance beyond the second distance, and so on.

In some examples, a device may provide feedback to indicate an option (e.g., haptic feedback such as vibration, audio feedback such as a different chime for each option, etc.). In one example, a first chime with a first tone may sound for showing or selecting a first option, while a second chime different than the first chime may sound for showing or selecting a second option. In another example, a single vibration pulse or a vibration of a first duration may be generated for showing or selecting a first option, while two vibration pulses or a vibration of a second duration longer than the first duration may be generated for showing or selecting a second option, and three vibration pulses or a vibration of a third duration longer than the second duration may be generated for showing or selecting a third option, etc.

In some examples, the describe techniques include selecting the first option, or the second option, or the third option, etc., in conjunction with the swipe. In some examples, selecting an option (e.g., the first option, the second option, etc.) may include a user releasing a swipe (e.g., the user lifting the finger or screen pen used to make the swipe gesture across the screen of the device). For example, a first option may be displayed based on a user swiping within a first distance and the user may select the first option by releasing the swipe (e.g., lifting the finger or screen pen) while the first option is being displayed. In some examples, the user may select the first option by swiping in an opposite direction (e.g., swiping right to initiate the swipe and show the first option, then swiping left, or up, or down to select the first option). In some examples, a first option may be displayed based on a user swiping right, and the user may select the first option by then swiping to the left until the first option is highlighted (e.g., visual feedback), or until a chime is sounded (e.g., audio feedback), or until a vibration (e.g., haptic feedback), or any combination thereof, the one or more feedbacks indicating the first option is selected for execution upon the user lifting the finger or screen pen at its current position or relatively at the current position (e.g., variation of finger position due to slight movements of slight vibrations of the finger or screen pen). In some examples, a user may select an option (e.g., first option, etc.) by pressing the screen while an option is being displayed. For example, a pressure sensor associated with the screen may sense the user pressing the screen (e.g., applying additional pressure than is applied by swiping) while an option is being displayed. Accordingly, the user may select the displayed option by initiating the swipe and then pressing the screen without lifting the finger or screen pen from the screen after initiating the swipe.

Aspects of the disclosure are initially described in the context of various user interface systems and flowcharts. Aspects of the disclosure are further illustrated by and described with reference to apparatus diagrams, system diagrams, and flowcharts that relate to multi-option swipe gesture selection.

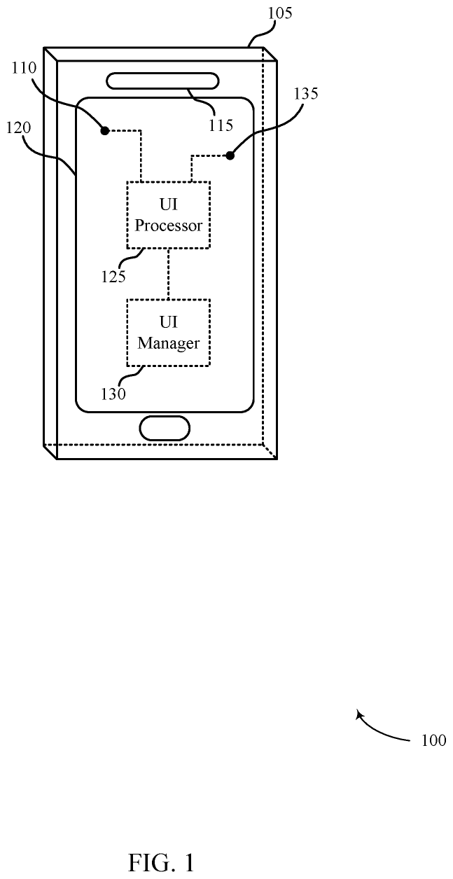

FIG. 1 illustrates an example of a user interface system 100 that supports multi-option swipe gesture selection in accordance with aspects of the present disclosure. The user interface system 100 includes a device 105. Examples of device 105 may include a smart phone device, a personal digital assistant, a tablet computer, a laptop computer, a desktop computer, a handheld gaming device, or any combination thereof. As shown, device 105 may include one or more sensors 110, at least one speaker 115, a screen 120 (e.g., integrated with the one or more sensors 110), a user interface (UI) processor 125 connected to the one or more sensors 110, a UI manager 130 connected to the UI processor 125, and haptic device 135 connected to UI processor 125. Examples of the one or more sensors 110 may include touchscreen sensors, capacitive sensors, resistive sensors, pressure sensor, optical imaging sensors, surface acoustic wave sensors, infrared grid sensors, dispersive signal sensors, acoustic pulse sensors, or any combination thereof. In some examples, one or more sensors 110 may be configured to detect swiping gestures relative to screen 120.

In some examples, device 105 may be configured to run an operating system, execute software applications, and execute system processes. In some examples, device 105 may be configured to generate, or receive, or display notifications associated with the operating system, or the software applications, or the system processes, or any combination thereof. In some examples, device 105 may be configured to detect (e.g., via the one or more sensors 110) a swiping gesture associated with a notification. In some examples, each of the one or more sensors 110 may be monitored simultaneously by UI manager 130, in conjunction with UI processor 125. For example, UI manager 130, in conjunction with UI processor 125, may monitor one or more parameters per sensor 110 (e.g., detecting a touch on screen 120, determining a location of the touch, detecting a swiping gesture, detecting a releasing of the swiping gesture, detecting a finger lifting off of screen 120, detecting a tap on screen 120, etc.). In some examples, device 105 may be configured to enable a user to perform an action by detecting the user swiping a notification (e.g., dragging a finger or screen interface pen across screen 120) and detecting the user releasing the swipe. In some examples, device 105 may be configured to display on screen 120 two or more options for actions associated with the notification based on UI manager 130, in conjunction with UI processor 125, determining how far the user swipes the notification. For example, UI manager 130, in conjunction with UI processor 125, may determine a distance of a swipe relative to an edge of screen 120, or determine a distance of a swipe relative to a determined location of where the swipe is initiated, etc.). In some examples, device 105 may show a first option (e.g., a first optional action to take associated with the notification) for a swipe determined to be up to a first distance, show a second option for a swipe determined to be up to a second distance and determined to be beyond the first distance, and show a third option for a swipe determined to be up to a third distance and determined to be beyond the second distance, and so on.

In some examples, device 105 may be configured to enable a user to select the first option, or the second option, or the third option, etc., in conjunction with the device 105 detecting and analyzing a swipe gesture of the user. In some examples, device 105 may detect the user releasing a swipe (e.g., detecting the user lifting the finger or screen pen used to make the swipe gesture across screen 120). For example, device 105 may show a first option based on determining the user swiped within a first distance and may execute an action associated with the first option based on determining the user released the swipe (e.g., lifted the finger or screen pen) while the first option was being displayed. In some examples, device 105 may determine the user selects the first option by detecting the user swiping in an opposite direction while the first option was being displayed. For example, device 105 may show the first option based on device 105 detecting the user swiping right to initiate the swipe, then device 105 may detect the user swiping left, or up, or down to select the first option. In some examples, device 105 may detect a user selecting an option by detecting pressure or detecting additional pressure being applied to screen 120 while an option is being displayed (e.g., determining a pressure applied to screen 120 satisfies a pressure threshold). For example, a pressure sensor (e.g., sensor 110) associated with screen 120 may sense a user pressing the screen (e.g., applying additional pressure than is applied by swiping) while an option is being displayed. Accordingly, device 105 may enable the user to select the displayed option by detecting the user initiating the swipe and then detecting the user pressing screen 120 without lifting the finger or screen pen from screen 120 after initiating the swipe.

In some examples, device 105 may provide feedback to indicate an option is being shown or has been selected. In one example, device 105 may provide haptic feedback via haptic device 135 (e.g., vibration from a vibration motor of haptic device 135, etc.). In one example, device 105 may provide audio feedback via speaker 115 (e.g., playing a first chime for a first option, playing a second chime different than the first chime for a second option, etc.). In some examples, device 105 may display a first option on display 205 based on detecting a user swiping right. In some examples, device 105 may then detect the user swiping to the left to indicate the user is selecting the first option. In some examples, upon determining the user selected the first option device 105 may provide visual feedback (e.g., highlight the selected option, change a color of the displayed option, etc.), or may play a chime (e.g., audio feedback), or perform a vibration (e.g., haptic feedback), or any combination thereof, the one or more feedbacks to indicate the first option is selected for execution.

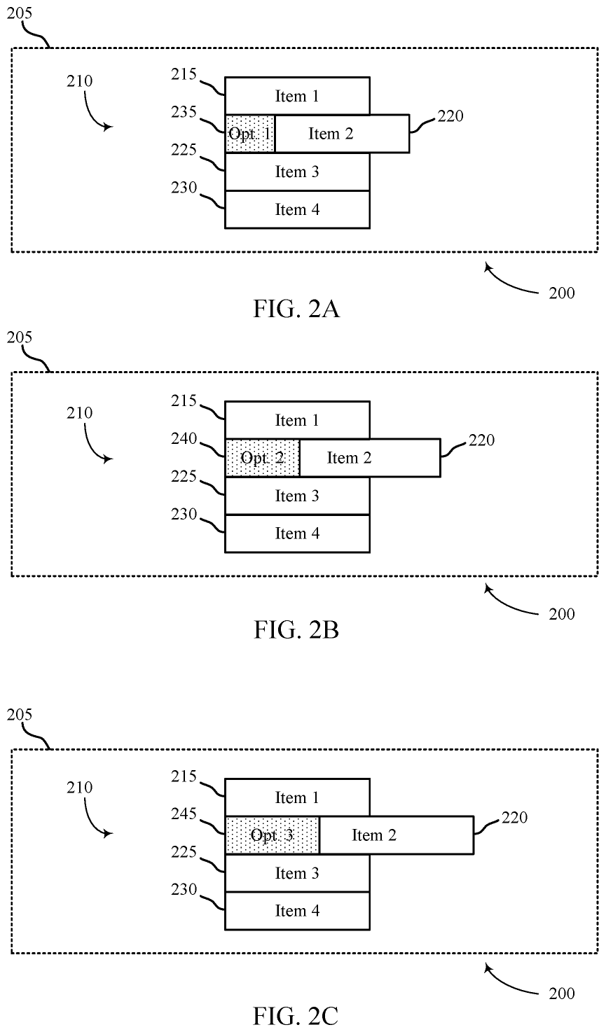

FIG. 2A illustrates an example of a system 200 that supports multi-option swipe gesture selection in accordance with aspects of the present disclosure. In some examples, system 200 may implement aspects of user interface system 100. System 200 may include display 205 (e.g., screen 120 or portion of screen 120 of FIG. 1). In the illustrated example, display 205 may display user interface 210. In some examples, display user interface 210 may be displayed in conjunction with one or more processors (e.g., UI processor 125 of FIG. 1).

As shown, user interface 210 may include first item 215, second item 220, third item 225, and fourth item 230. Example of items 215-230 include a calendar reminder notification, or a link to open a calendar reminder, or an email notification, or a link to open an email, or a message notification, or a link to open a message, or a travel notification (e.g., notification associated with a scheduled flight, a public transportation service, a scheduled ridesharing service, etc.), or a paging notification (e.g., restaurant reservation, ridesharing reservation, public service reservation, etc.), or a location notification (e.g., mapping software indicating a user has arrived at a destination, etc.), or a mapping route notification (e.g., mapping software indicating a step of a route or a modification to a route, etc.), or a link to open a mobile application, or any combination thereof.

In the illustrated example, second item 220 is swiped to the right (e.g., via a detected swiping gesture of a user). Although depicted showing a swiping gesture to the right, it is understood the swiping gesture may be initiated in any direction (e.g., left, right, up, down, etc.). As shown, user interface 210 displays first option 235 as a result of a distance of the swiping gesture of second item 220 being determined to be within a first span (e.g., by a device such as device 105).

In some examples, a user may execute an action associated with first option 235 by releasing the swipe (e.g., the device detecting the user lifting the finger or screen pen) while the first option 235 is being displayed, or by swiping in an opposite direction (e.g., the device detecting the user swiping left, or up, or down after swiping right to initiate), or by swiping in an opposite direction until a feedback is provided (e.g., until the device provides visual feedback, audio feedback, haptic feedback, etc., based on the device detecting the user selecting first option 235), or by pressing the screen while first option 235 is being displayed (e.g., the device determining pressure applied to display 205 exceeds a pressure threshold), or any combination thereof. Accordingly, the user may select the first option 235 by initiating the swipe and then performing a selection gesture, all without lifting the finger or screen pen from display 205 after initiating the swipe.

FIG. 2B illustrates an example of a system 200 that supports multi-option swipe gesture selection in accordance with aspects of the present disclosure. In some examples, system 200 may implement aspects of user interface system 100.

As shown, user interface 210 may include first item 215, second item 220, third item 225, and fourth item 230. In the illustrated example, second item 220 is swiped to the right (e.g., via a swiping gesture of a user detected by a device such as device 105 of FIG. 1). As shown, user interface 210 displays a second option 240 on display 205 as a result of a distance of the swiping gesture of second item 220 being within a second span that is greater than the first span.

In some examples, a user may execute an action associated with second option 240 by releasing the swipe (e.g., the device detecting the user lifting the finger or screen pen) while the second option 240 is being displayed, or by swiping in an opposite direction (e.g., the device detecting the user swiping left, or up, or down after swiping right to initiate), or by swiping in an opposite direction until a feedback is provided (e.g., until the device provides visual feedback, audio feedback, haptic feedback, etc., based on the device detecting the user selecting second option 240), or by pressing the screen while first option 235 is being displayed (e.g., the device determining pressure applied to display 205 exceeds a pressure threshold), or any combination thereof. Accordingly, the user may select the second option 240 by initiating the swipe and then performing a selection gesture, all without lifting the finger or screen pen from display 205 after initiating the swipe.

FIG. 2C illustrates an example of a system 200 that supports multi-option swipe gesture selection in accordance with aspects of the present disclosure. In some examples, system 200 may implement aspects of user interface system 100.

As shown, user interface 210 may include first item 215, second item 220, third item 225, and fourth item 230. In the illustrated example, second item 220 is swiped to the right (e.g., via a swiping gesture of a user detected by a device such as device 105 of FIG. 1). As shown, user interface 210 displays a second option 240 on display 205 as a result of a distance of the swiping gesture of second item 220 being within a third span that is greater than the second span.

In some examples, a user may execute an action associated with second option 240 by releasing the swipe (e.g., the device detecting the user lifting the finger or screen pen) while the second option 240 is being displayed, or by swiping in an opposite direction (e.g., the device detecting the user swiping left, or up, or down after swiping right to initiate), or by swiping in an opposite direction until a feedback is provided (e.g., until the device provides visual feedback, audio feedback, haptic feedback, etc., based on the device detecting the user selecting second option 240), or by pressing the screen while third option 245 is being displayed (e.g., the device determining pressure applied to display 205 exceeds a pressure threshold), or any combination thereof. Accordingly, the user may select the third option 245 by initiating the swipe and then performing a selection gesture, all without lifting the finger or screen pen from display 205 after initiating the swipe. In some examples, a user may select the second option 240 by swiping a first distance to the left while second option 240 is being displayed. In some examples, the user may continue to swipe to the left a second distance to the left beyond the first distance to stop showing the second option 240 and show or reshow the first option 235.

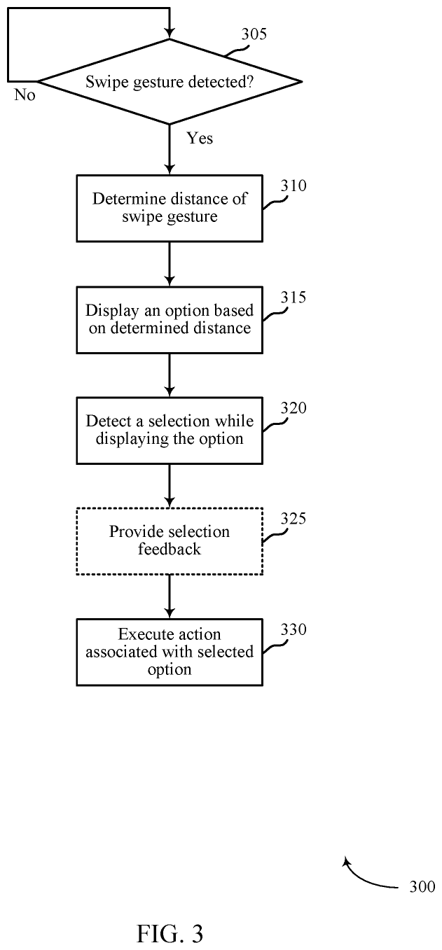

FIG. 3 illustrates an example of a method 300 that supports multi-option swipe gesture selection in accordance with aspects of the present disclosure. In some examples, method 300 may implement aspects of user interface system 100. The operations of method 300 may be implemented by a device (e.g., device 105) or one or more components of the device as described herein. For example, the operations of method 300 may be performed by a UI manager as described with reference to FIGS. 1, 2, and 4 through 7. In some examples, a device may execute a set of instructions to control the functional elements of the device to perform the functions described herein. Additionally or alternatively, a device may perform aspects of the functions described herein using special-purpose hardware.

At 305, the device may monitor for swiping gestures and determine whether a swiping gesture is detected. When the device determines that a swiping gesture is not detected, the device may continue monitoring for swiping gestures. When the device determines that a swiping gesture is detected, the device may proceed to analyze the detected swiping gesture. The operations of 305 may be performed according to the methods described herein. In some examples, aspects of the operations of 305 may be performed by a UI manager as described with reference to FIGS. 1, 2, and 4 through 7.

At 310, the device may determine a distance of the detected swiping gesture. In some examples, the device may determine the distance based on a difference of a detected ending point of the swipe gesture and a detected starting point of the swipe gesture. In some examples, the device may determine that the distance of the detected swiping gesture is within a first span (e.g., exceeds a first distance threshold and does not exceed a second distance threshold) or determine that the distance of the detected swiping gesture is within a second span (e.g., exceeds the second distance threshold and does not exceed a third distance threshold), etc. The operations of 310 may be performed according to the methods described herein. In some examples, aspects of the operations of 305 may be performed by a UI manager as described with reference to FIGS. 1, 2, and 4 through 7.

At 315, the device may display an option based on the determined distance. In some examples, the device may display a first option when the determined distance of the detected swiping gesture is within the first span, or display a second option when the determined distance of the detected swiping gesture is within the second span, etc. The operations of 315 may be performed according to the methods described herein. In some examples, aspects of the operations of 305 may be performed by a UI manager as described with reference to FIGS. 1, 2, and 4 through 7.

At 320, the device may detect a selection while displaying the option. For example, the device may determine the user performed a selection gesture (e.g., a swipe in a different direction, etc.) when an option is being displayed. The operations of 320 may be performed according to the methods described herein. In some examples, aspects of the operations of 305 may be performed by a UI manager as described with reference to FIGS. 1, 2, and 4 through 7.

At 325, the device may optionally provide a selection feedback to indicate that the displayed option has been selected. The operations of 325 may be performed according to the methods described herein. In some examples, aspects of the operations of 305 may be performed by a UI manager as described with reference to FIGS. 1, 2, and 4 through 7.

At 330, the device may execute an action based on the device detecting the user selected the displayed option. The operations of 330 may be performed according to the methods described herein. In some examples, aspects of the operations of 305 may be performed by a UI manager as described with reference to FIGS. 1, 2, and 4 through 7.

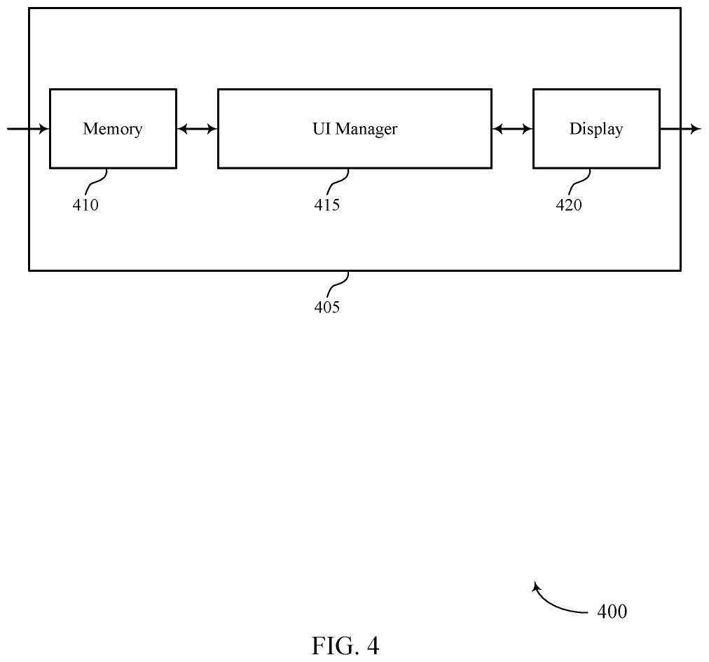

FIG. 4 shows a block diagram 400 of a device 405 that supports multi-option swipe gesture selection in accordance with aspects of the present disclosure. The device 405 may be an example of aspects of a device as described herein. The device 405 may include a receiver 410, an UI manager 415, and a display 420. The device 405 may also include a processor. Each of these components may be in communication with one another (e.g., via one or more buses).

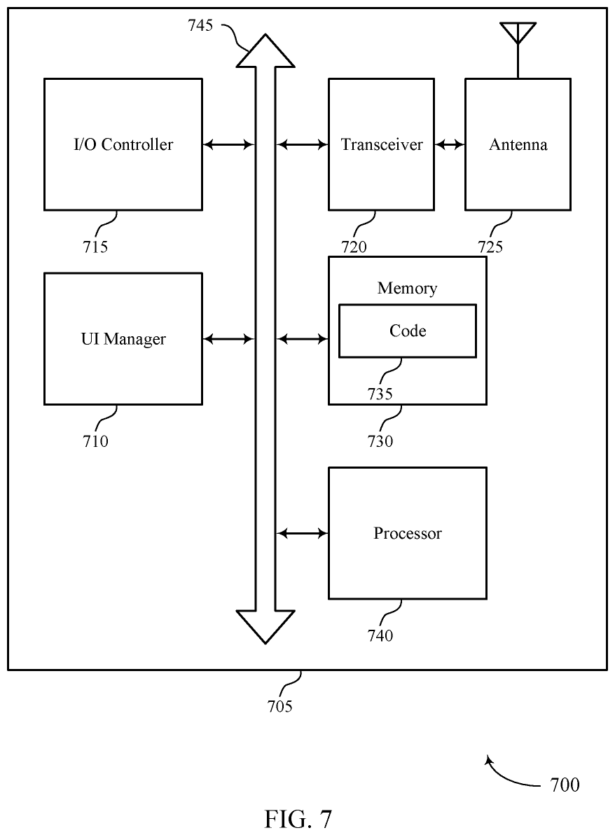

The memory 410 may store information (e.g., monitoring data, change detection data, analysis data, image metadata) generated by other components of device 405 such as UI manager 415. For example, memory 410 may store one or more images samples that UI manager 415 compares with an output of UI manager 415. In some examples, the memory 410 may be collocated with one or more processors in a computing device (e.g., device 405). For example, the memory 410 may be an example of aspects of the memory 730 described with reference to FIG. 7. Memory 410 may comprise one or more computer-readable storage media. Examples of memory 410 include, but are not limited to, random access memory (RAM), static RAM (SRAM), dynamic RAM (DRAM), read-only memory (ROM), electrically erasable programmable read-only memory (EEPROM), compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor (e.g., UI manager 415).

The UI manager 415 may display the user interface element on a screen of the device, display a first option when a distance of the swipe gesture is determined to be within a first span, display a second option when the distance of the swipe gesture is beyond the first span and within a second span that is greater than the first span, sense a swipe gesture on the screen that is associated with the user interface element, sense a selection gesture while displaying the first option or the second option, and execute either a first process based on sensing the selection gesture while displaying the first option or a second process based on sensing the selection gesture while displaying the second option. The UI manager 415 may be an example of aspects of the UI manager 710 described herein.

The UI manager 415, or its sub-components, may be implemented in hardware, code (e.g., software or firmware) executed by a processor, or any combination thereof. If implemented in code executed by a processor, the functions of the UI manager 415, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The UI manager 415, or its sub-components, may be physically located at various positions, including being distributed such that portions of functions are implemented at different physical locations by one or more physical components. In some examples, the UI manager 415, or its sub-components, may be a separate and distinct component in accordance with various aspects of the present disclosure. In some examples, the UI manager 415, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

In some examples, display 420 may display graphics based on processing performed by UI manager 415. In some examples, display 420 may or at least some of its sub-components may be implemented in hardware, software executed by a processor, firmware, or any combination thereof. When implemented in software executed by a processor, the functions of the display 420 or at least some of its various sub-components may be executed by UI manager 415, which may include at least one of a general-purpose processor, a DSP, an ASIC, an FPGA or other programmable logic device, discrete gate or transistor logic, discrete hardware components, or any combination thereof designed to perform the functions described in the present disclosure.

Accordingly, UI manager 415 enables a user of device 405 to select a displayed option by initiating a swipe with a finger or pen and then swiping along the screen without lifting the finger or screen pen from display 420 after initiating the swipe. Thus, UI manager 415 minimizes the gestures a user has to perform to interact with notifications and other UI elements displayed on display 420 by enabling a user to interact with notifications and other UI elements on display 420 without having to swipe, release the swipe, and then perform one or more additional steps after releasing the swipe (e.g., tap an action button shown on the display after swiping, etc.).

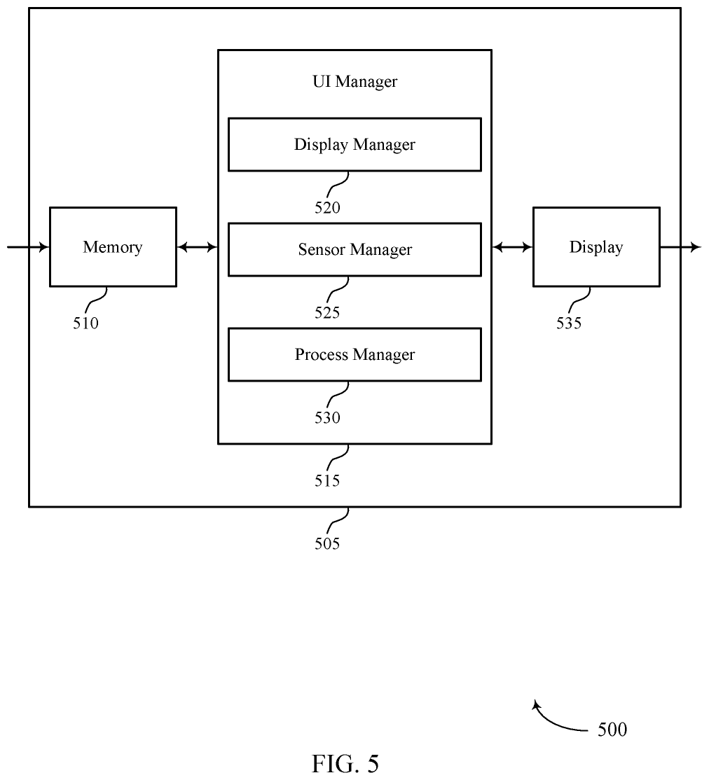

FIG. 5 shows a block diagram 500 of a device 505 that supports multi-option swipe gesture selection in accordance with aspects of the present disclosure. The device 505 may be an example of aspects of a device 405 or a device 115 as described herein. The device 505 may include a memory 510, a UI manager 515, and a display 535. The device 505 may also include a processor. Each of these components may be in communication with one another (e.g., via one or more buses).

The memory 510 may receive, transmit, or store information, data, or signals generated by other components of the device 505. In some examples, the memory 510 may be collocated with one or more processors in a computing device (e.g., device 505). In some examples, the memory 510 may be an example of aspects of memory 730 described with reference to FIG. 7.

The UI manager 515 may be an example of aspects of the UI manager 415 as described herein. The UI manager 515 may include a display manager 520, a sensor manager 525, and a process manager 530. The UI manager 515 may be an example of aspects of the UI manager 710 described herein.

The display manager 520 may display the user interface element on a screen of the device, display a first option when a distance of the swipe gesture is determined to be within a first span, and display a second option when the distance of the swipe gesture is beyond the first span and within a second span that is greater than the first span.

The sensor manager 525 may sense a swipe gesture on the screen that is associated with the user interface element and sense a selection gesture while displaying the first option or the second option.

The process manager 530 may execute either a first process based on sensing the selection gesture while displaying the first option or a second process based on sensing the selection gesture while displaying the second option.

In some examples, display 535 may display graphics based on processing performed by UI manager 515 (e.g., processing of alias instructions by UI manager 515). In some examples, display 535 may or at least some of its sub-components may be implemented in hardware, software executed by a processor, firmware, or any combination thereof. When implemented in software executed by a processor, the functions of the display 535 or at least some of its various sub-components may be executed by UI manager 315, which may include at least one of a general-purpose processor, a DSP, an ASIC, an FPGA or other programmable logic device, discrete gate or transistor logic, discrete hardware components, or any combination thereof designed to perform the functions described in the present disclosure.

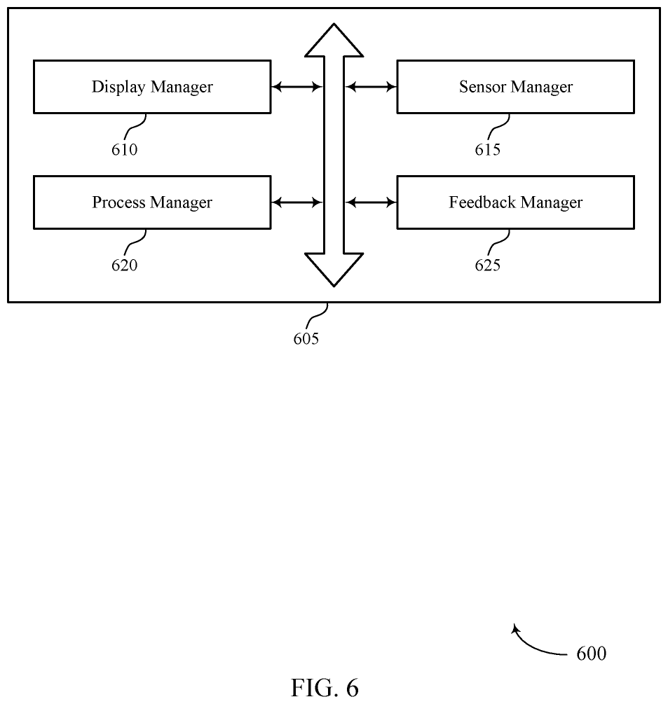

FIG. 6 shows a block diagram 600 of a UI manager 605 that supports multi-option swipe gesture selection in accordance with aspects of the present disclosure. The UI manager 605 may be an example of aspects of a UI manager 415, a UI manager 515, or a UI manager 710 described herein. The UI manager 605 may include a display manager 610, a sensor manager 615, a process manager 620, and a feedback manager 625. Each of these modules may communicate, directly or indirectly, with one another (e.g., via one or more buses).

The display manager 610 may display the user interface element on a screen of a device. In some cases, the device includes a mobile computing device, a personal computing device, a wearable computing device, a screen projector, or a virtual reality headset.

In some cases, the user interface element includes at least one of a calendar reminder notification, or a link to open a calendar reminder, or an email notification, or a link to open an email, or a message notification, or a link to open a message, or a travel notification, or a paging notification, or a location notification, or a mapping route notification, or a link to open a mobile application, or any combination thereof.

In some examples, the display manager 610 may display a first option when a distance of the swipe gesture is determined to be within a first span. In some examples, the display manager 610 may display a second option when the distance of the swipe gesture is beyond the first span and within a second span that is greater than the first span. In some cases, the first span includes a distance from a first point on the screen to a second point on the screen, and where the second span includes a distance from the first point on the screen to a third point on the screen.

The sensor manager 615 may sense a swipe gesture on the screen that is associated with the user interface element. In some examples, the sensor manager 615 may sense a selection gesture while displaying the first option or the second option.

In some cases, the selection gesture includes at least one of a release of the swipe gesture, or a second swipe gesture in a direction different than a direction of the swipe gesture, or sensing an increase in pressure applied to the screen, or any combination thereof. In some cases, the release of the swipe gesture includes a lifting of a finger from the screen, a releasing of a mouse button, or a second swipe gesture by a hand in the air in an augmented reality associated with the screen.

The process manager 620 may execute either a first process based on sensing the selection gesture while displaying the first option or a second process based on sensing the selection gesture while displaying the second option.

The feedback manager 625 may provide a first feedback in conjunction with displaying the first option.

In some examples, the feedback manager 625 may provide a second feedback in conjunction with displaying the second option. In some cases, the first feedback or the second feedback includes at least one of a haptic feedback, or a graphical feedback, or an audio feedback, or any combination thereof.

FIG. 7 shows a diagram of a system 700 including a device 705 that supports multi-option swipe gesture selection in accordance with aspects of the present disclosure. The device 705 may be an example of or include the components of device 405, device 505, or a device as described herein. The device 705 may include components for bi-directional voice and data communications including components for transmitting and receiving communications, including an UI manager 710, an I/O controller 715, a transceiver 720, an antenna 725, memory 730, a processor 740, and a coding manager 750. These components may be in electronic communication via one or more buses (e.g., bus 745).

The UI manager 710 may display the user interface element on a screen of the device, display a first option when a distance of the swipe gesture is determined to be within a first span, display a second option when the distance of the swipe gesture is beyond the first span and within a second span that is greater than the first span, sense a swipe gesture on the screen that is associated with the user interface element, sense a selection gesture while displaying the first option or the second option, and execute either a first process based on sensing the selection gesture while displaying the first option or a second process based on sensing the selection gesture while displaying the second option.

The I/O controller 715 may manage input and output signals for the device 705. The I/O controller 715 may also manage peripherals not integrated into the device 705. In some cases, the I/O controller 715 may represent a physical connection or port to an external peripheral. In some cases, the I/O controller 715 may utilize an operating system such as iOS®, ANDROID®, MS-DOS®, MS-WINDOWS®, OS/2®, UNIX®, LINUX®, or another known operating system. In other cases, the I/O controller 715 may represent or interact with a modem, a keyboard, a mouse, a touchscreen, or a similar device. In some cases, the I/O controller 715 may be implemented as part of a processor. In some cases, a user may interact with the device 705 via the I/O controller 715 or via hardware components controlled by the I/O controller 715.

The transceiver 720 may communicate bi-directionally, via one or more antennas, wired, or wireless links as described herein. For example, the transceiver 720 may represent a wireless transceiver and may communicate bi-directionally with another wireless transceiver. The transceiver 720 may also include a modem to modulate the packets and provide the modulated packets to the antennas for transmission, and to demodulate packets received from the antennas.

In some cases, the wireless device may include a single antenna 725. However, in some cases the device may have more than one antenna 725, which may be capable of concurrently transmitting or receiving multiple wireless transmissions.

The memory 730 may include RAM and ROM. The memory 730 may store computer-readable, computer-executable code 735 including instructions that, when executed, cause the processor to perform various functions described herein. In some cases, the memory 730 may contain, among other things, a BIOS which may control basic hardware or software operation such as the interaction with peripheral components or devices.

The processor 740 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In other cases, a memory controller may be integrated into the processor 740. The processor 740 may be configured to execute computer-readable instructions stored in a memory (e.g., the memory 730) to cause the device 705 to perform various functions (e.g., functions or tasks supporting multi-option swipe gesture selection).

The code 735 may include instructions to implement aspects of the present disclosure, including instructions to support multi-option swipe gesture selection. The code 735 may be stored in a non-transitory computer-readable medium such as system memory or other type of memory. In some cases, the code 735 may not be directly executable by the processor 740 but may cause a computer (e.g., when compiled and executed) to perform functions described herein.

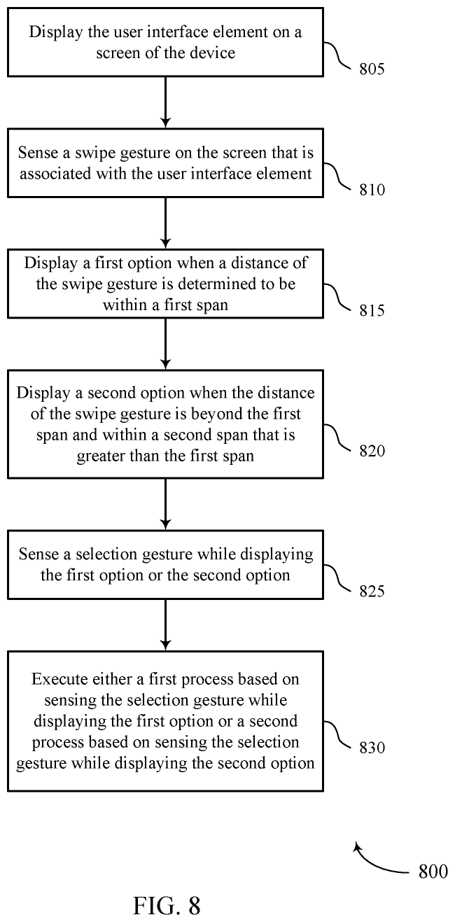

FIG. 8 shows a flowchart illustrating a method 800 that supports multi-option swipe gesture selection in accordance with aspects of the present disclosure. The operations of method 800 may be implemented by a device or its components as described herein. For example, the operations of method 800 may be performed by a UI manager as described with reference to FIGS. 4 through 7. In some examples, a device may execute a set of instructions to control the functional elements of the device to perform the functions described herein. Additionally or alternatively, a device may perform aspects of the functions described herein using special-purpose hardware.

At 805, the device may display the user interface element on a screen of the device. The operations of 805 may be performed according to the methods described herein. In some examples, aspects of the operations of 805 may be performed by a display manager as described with reference to FIGS. 4 through 7.

At 810, the device may sense a swipe gesture on the screen that is associated with the user interface element. The operations of 810 may be performed according to the methods described herein. In some examples, aspects of the operations of 810 may be performed by a sensor manager as described with reference to FIGS. 4 through 7.

At 815, the device may display a first option when a distance of the swipe gesture is determined to be within a first span. The operations of 815 may be performed according to the methods described herein. In some examples, aspects of the operations of 815 may be performed by a display manager as described with reference to FIGS. 4 through 7.

At 820, the device may display a second option when the distance of the swipe gesture is beyond the first span and within a second span that is greater than the first span. The operations of 820 may be performed according to the methods described herein. In some examples, aspects of the operations of 820 may be performed by a display manager as described with reference to FIGS. 4 through 7.

At 825, the device may sense a selection gesture while displaying the first option or the second option. The operations of 825 may be performed according to the methods described herein. In some examples, aspects of the operations of 825 may be performed by a sensor manager as described with reference to FIGS. 4 through 7.

At 830, the device may execute either a first process based on sensing the selection gesture while displaying the first option or a second process based on sensing the selection gesture while displaying the second option. The operations of 830 may be performed according to the methods described herein. In some examples, aspects of the operations of 830 may be performed by a process manager as described with reference to FIGS. 4 through 7.

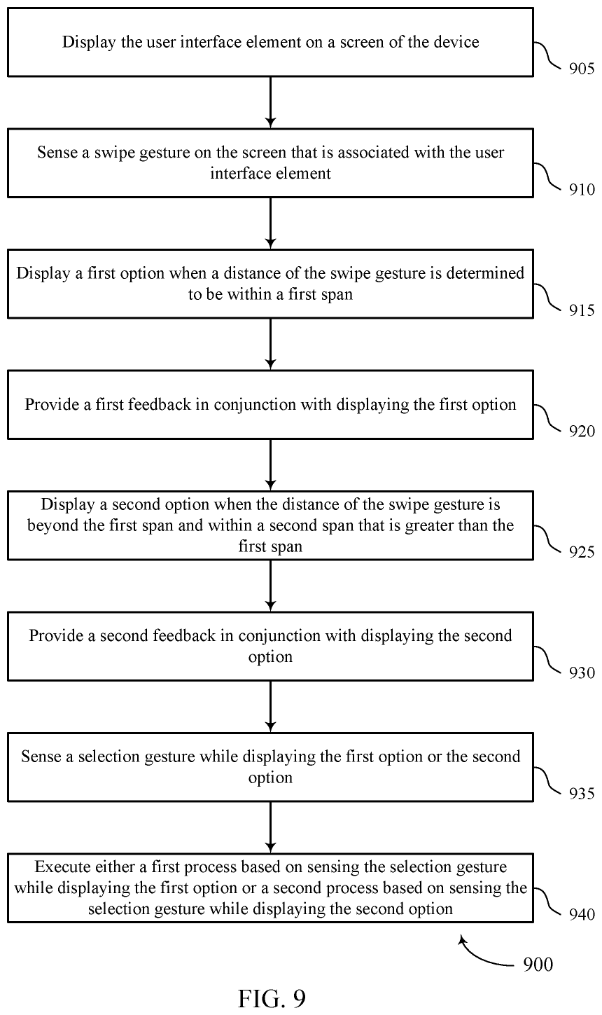

FIG. 9 shows a flowchart illustrating a method 900 that supports multi-option swipe gesture selection in accordance with aspects of the present disclosure. The operations of method 900 may be implemented by a device or its components as described herein. For example, the operations of method 900 may be performed by a UI manager as described with reference to FIGS. 4 through 7. In some examples, a device may execute a set of instructions to control the functional elements of the device to perform the functions described herein. Additionally or alternatively, a device may perform aspects of the functions described herein using special-purpose hardware.

At 905, the device may display the user interface element on a screen of the device. The operations of 905 may be performed according to the methods described herein. In some examples, aspects of the operations of 905 may be performed by a display manager as described with reference to FIGS. 4 through 7.

At 910, the device may sense a swipe gesture on the screen that is associated with the user interface element. The operations of 910 may be performed according to the methods described herein. In some examples, aspects of the operations of 910 may be performed by a sensor manager as described with reference to FIGS. 4 through 7.

At 915, the device may display a first option when a distance of the swipe gesture is determined to be within a first span. The operations of 915 may be performed according to the methods described herein. In some examples, aspects of the operations of 915 may be performed by a display manager as described with reference to FIGS. 4 through 7.

At 920, the device may provide a first feedback in conjunction with displaying the first option. The operations of 920 may be performed according to the methods described herein. In some examples, aspects of the operations of 920 may be performed by a display manager as described with reference to FIGS. 4 through 7.

At 925, the device may display a second option when the distance of the swipe gesture is beyond the first span and within a second span that is greater than the first span. The operations of 925 may be performed according to the methods described herein. In some examples, aspects of the operations of 925 may be performed by a sensor manager as described with reference to FIGS. 4 through 7.

At 930, the device may provide a second feedback in conjunction with displaying the second option. The operations of 930 may be performed according to the methods described herein. In some examples, aspects of the operations of 930 may be performed by a process manager as described with reference to FIGS. 4 through 7.

At 935, the device may sense a selection gesture while displaying the first option or the second option. The operations of 935 may be performed according to the methods described herein. In some examples, aspects of the operations of 935 may be performed by a feedback manager as described with reference to FIGS. 4 through 7.

At 940, the device may execute either a first process based on sensing the selection gesture while displaying the first option or a second process based on sensing the selection gesture while displaying the second option. The operations of 940 may be performed according to the methods described herein. In some examples, aspects of the operations of 940 may be performed by a feedback manager as described with reference to FIGS. 4 through 7.

It should be noted that the methods described herein describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for interacting with a user interface element at a device, comprising:
displaying the user interface element on a screen of the device;
sensing a swipe gesture on the screen that is associated with the user interface element;
displaying a first option when a distance of the swipe gesture is determined to be within a first span;
providing a first feedback to indicate the first option is being displayed and is selected for execution, wherein the first feedback comprises at least a first haptic feedback and a first graphical feedback;
displaying a second option when the distance of the swipe gesture is beyond the first span and within a second span that is greater than the first span;
providing a second feedback to indicate the second option is being displayed and is selected for execution, wherein the second feedback comprises at least a second haptic feedback different from the first haptic feedback and a second graphical feedback different from the first graphical feedback;
sensing a selection gesture while displaying the first option or the second option; and
executing either a first process based at least in part on sensing the selection gesture while displaying the first option or a second process based at least in part on sensing the selection gesture while displaying the second option.

2. (canceled)

3. The method of claim 2, wherein the first feedback comprises an audio feedback, and wherein the second feedback comprises a second audio feedback.

4. The method of claim 1, wherein the selection gesture comprises at least one of a release of the swipe gesture, or a second swipe gesture in a direction different than a direction of the swipe gesture, or sensing an increase in pressure applied to the screen, or any combination thereof.

5. The method of claim 4, wherein the release of the swipe gesture comprises a lifting of a finger from the screen, a releasing of a mouse button, or a second swipe gesture by a hand in the air in an augmented reality associated with the screen.

6. The method of claim 1, wherein the user interface element comprises at least one of a calendar reminder notification, or a link to open a calendar reminder, or an email notification, or a link to open an email, or a message notification, or a link to open a message, or a travel notification, or a paging notification, or a location notification, or a mapping route notification, or a link to open a mobile application, or any combination thereof.

7. The method of claim 1, wherein the first span comprises a distance from a first point on the screen to a second point on the screen, and wherein the second span comprises a distance from the first point on the screen to a third point on the screen.

8. The method of claim 1, wherein the device comprises a mobile computing device, a personal computing device, a wearable computing device, a screen projector, or a virtual reality headset.

9. An apparatus for interacting with a user interface element at a device, comprising:
a processor,
memory coupled with the processor; and
instructions stored in the memory and executable by the processor to cause the apparatus to:
display the user interface element on a screen of the device;
sense a swipe gesture on the screen that is associated with the user interface element;
display a first option when a distance of the swipe gesture is determined to be within a first span;
provide a first feedback to indicate the first option is being displayed and is selected for execution, wherein the first feedback comprises at least a first haptic feedback and a first graphical feedback;
display a second option when the distance of the swipe gesture is beyond the first span and within a second span that is greater than the first span;
provide a second feedback to indicate the second option is being displayed and is selected for execution, wherein the second feedback comprises at least a second haptic feedback different from the first haptic feedback and a second graphical feedback different from the first graphical feedback;
sense a selection gesture while displaying the first option or the second option; and
execute either a first process based at least in part on sensing the selection gesture while displaying the first option or a second process based at least in part on sensing the selection gesture while displaying the second option.

10. (canceled)

11. The apparatus of claim 10, wherein the first feedback comprises an audio feedback, and wherein the second feedback comprises a second audio feedback.

12. The apparatus of claim 9, wherein the selection gesture comprises at least one of a release of the swipe gesture, or a second swipe gesture in a direction different than a direction of the swipe gesture, or sensing an increase in pressure applied to the screen, or any combination thereof.

13. The apparatus of claim 12, wherein the release of the swipe gesture comprises a lifting of a finger from the screen, a releasing of a mouse button, or a second swipe gesture by a hand in the air in an augmented reality associated with the screen.

14. The apparatus of claim 9, wherein the user interface element comprises at least one of a calendar reminder notification, or a link to open a calendar reminder, or an email notification, or a link to open an email, or a message notification, or a link to open a message, or a travel notification, or a paging notification, or a location notification, or a mapping route notification, or a link to open a mobile application, or any combination thereof.

15. The apparatus of claim 9, wherein the first span comprises a distance from a first point on the screen to a second point on the screen, and wherein the second span comprises a distance from the first point on the screen to a third point on the screen.

16. The apparatus of claim 9, wherein the device comprises a mobile computing device, a personal computing device, a wearable computing device, a screen projector, or a virtual reality headset.

17. A non-transitory computer-readable medium storing code for interacting with a user interface element at a device, the code comprising instructions executable by a processor to:
display the user interface element on a screen of the device;
sense a swipe gesture on the screen that is associated with the user interface element;
display a first option when a distance of the swipe gesture is determined to be within a first span;
provide a first feedback to indicate the first option is being displayed and is selected for execution, wherein the first feedback comprises at least a first haptic feedback and a first graphical feedback;
display a second option when the distance of the swipe gesture is beyond the first span and within a second span that is greater than the first span;
provide a second feedback to indicate the second option is being displayed and is selected for execution, wherein the second feedback comprises at least a second haptic feedback different from the first haptic feedback and a second graphical feedback different from the first graphical feedback;
sense a selection gesture while displaying the first option or the second option; and
execute either a first process based at least in part on sensing the selection gesture while displaying the first option or a second process based at least in part on sensing the selection gesture while displaying the second option.

18. (canceled)

19. The non-transitory computer-readable medium of claim 18, wherein the first feedback comprises an audio feedback, and wherein the second feedback comprises a second audio feedback.

20. The non-transitory computer-readable medium of claim 17, wherein the selection gesture comprises at least one of a release of the swipe gesture, or a second swipe gesture in a direction different than a direction of the swipe gesture, or sensing an increase in pressure applied to the screen, or any combination thereof.
